(19) United States
(12) Patent Application Publication
(10) Pub. No.: US 2017/0005366 A1
(43) Pub. Date: Jan. 5, 2017

(54) OXIDE BASED SOLID ELECTROLYTE AND METHOD FOR PREPARING SAME

(71) Applicant: Electronics and Telecommunications Research Institute, Daejeon (KR)

(72) Inventors: Dong Ok SHIN, Daejeon (KR); Young-Gi LEE, Daejeon (KR); Kwang Man KIM, Daejeon (KR)

(73) Assignee: Electronics and Telecommunications Research Institute, Daejeon (KR)

(21) Appl. No.: 15/191,093

(22) Filed: Jun. 23, 2016

(30) Foreign Application Priority Data
Jun. 30, 2015 (KR) 10-2015-0093088
Dec. 10, 2015 (KR) 10-2015-0176127

(51) Int. Cl. H01M 10/0562; H01M 10/0525

(52) U.S. Cl. CPC H01M 10/0562; H01M 10/0525; H01M 2300/0071

(57) ABSTRACT

Provided is a method for preparing an oxide based solid electrolyte, the method comprising preparing a mixture including a lithium (Li) compound, a lanthanum (La) compound, and a metal compound, the metal compound including a first metal element represented by M, adding a first precursor including a second metal element and a second precursor including a third metal element to the mixture, and performing a crystallization operation to form a compound represented by LiₓLa₃M₂O₁₂ from the mixture having the first precursor and the second precursor mixed therein, wherein the compound is doped with the second and third metal elements.

This U.S. non-provisional patent application claims priority under 35 U.S.C. §119 of Korean Patent Application Nos. 10-2015-0093088, filed on Jun. 30, 2015, and 10-2015-0176127, filed on Dec. 10, 2015, the entire contents of which are hereby incorporated by reference.

### BACKGROUND

Example embodiments relate to a lithium battery, and more particularly, to an oxide based solid electrolyte and a method for preparing the same.

As the importance of energy storage and conversion techniques have increased, interest in lithium batteries has also increased. A lithium battery may include an anode, a separator, a cathode, and an electrolyte. The electrolyte functions as a medium through which ions can move between a positive electrode and a negative electrode. Lithium batteries have a high energy density compared to other batteries and may be small and lightweight. Thus, lithium batteries are being actively developed as power sources for mobile electronic devices. Recently, as the performance of mobile electronic devices has improved, the power consumed by mobile electronic devices has increased. There is a demand for lithium batteries that generate high power. Accordingly, there is a demand for an electrolyte having high ionic conductivity and low electronic conductivity to improve the output properties of the lithium battery electrolyte.

Lithium battery electrolytes may include organic liquid electrolytes and inorganic solid electrolytes. Organic liquid electrolytes have lithium salts dissolved therein and have a high ionic conductivity and stable electrochemical properties, and thus are widely used. However, due to organic liquid electrolytes being highly combustible and volatile, and having a limitation of leakage, there have been many issues raised regarding safety. Lithium batteries including organic solid electrolytes may have freedom with respect to battery design. Moreover, since ignition, explosion, and leakage due to a reduction reaction of an electrolyte solution and the like are prevented, inorganic solid electrolytes may have excellent stability.

### SUMMARY

An object of the present invention is to provide an oxide based solid electrolyte having high purity and ionic conductivity.

Another object of the present invention is to provide a method for preparing an oxide based solid electrolyte having high purity and ionic conductivity.

Objects of the present invention are not limited to the objects indicated above. Other objects which are not indicated may be clearly understood from the disclosure below by a person with ordinary skill in the art.

Some embodiments of the inventive concept for such objects provides a method for preparing an oxide based solid electrolyte, the method, the method including preparing a mixture including a lithium (Li) compound, a lanthanum (La) compound, and a metal compound, the metal compound including a first metal element represented by M; adding a first precursor including a second metal element and a second precursor including a third metal element to the mixture; and performing a crystallization operation to form a compound from the mixture having the first precursor and the second precursor mixed therein, the compound being represented by Formula 1.

LiₓLa₃M₂O₁₂ <Formula 1>

In Formula 1, x is an integer of about 5 to 9 and M is one of tantalum

(Ta), niobium (Nb), zirconium (Zr), scandium (Sc), yttrium (Y), and vanadium (V).

In some embodiments, the compound may be doped with the second metal element and the third metal element.

In some embodiments, the first and second metal elements may include different materials from each other, the second metal element being substituted into the Li position in Formula 1 and the third metal element being substituted into the M position in Formula 1.

In some embodiments, the second metal element may include at least one of aluminum (Al), gallium (Ga), indium (In), titanium (Ti), silicon (Si), germanium (Ge), tin (Sn) or lead (Pb).

In some embodiments, the third metal element may include at least one of tantalum (Ta), niobium (Nb), zirconium (Zr), scandium (Sc), yttrium (Y), or vanadium (V).

In some embodiments, the compound may have a cubic phase.

In some embodiments, the performing of the crystallization operation may include performing a first heat treatment on the compound to form an intermediate that has a cubic phase; and performing a second heat treatment on the intermediate to form the compound.

In some embodiments, the intermediate may have the same stoichiometric composition as the compound.

In some embodiments, the compound may have a higher ionic conductivity than the intermediate.

In some embodiments, the first heat treatment may be performed for about 2 to 4 hours at about 800° C. to 1000° C.

In some embodiments, adding a sintering agent to the intermediate before performing the second heat treatment may be further included.

In some embodiments, the sintering agent may include one of boron trioxide (B₂O₃), manganese (IV) oxide (MnO₂), and lithium tetraborate (Li₂B₄O₇).

In some embodiments, the second heat treatment may be performed for about 1 to 30 hours at about 1000° C. to 1200° C.

In some embodiments of the inventive concept, an oxide based solid electrolyte includes a compound represented by Formula 1.

LiₓLa₃M₂O₁₂ <Formula 1>

In Formula 1, x is an integer of about 5 to 9 and M is one of tantalum (Ta), niobium (Nb), zirconium (Zr), scandium (Sc), yttrium (Y), and vanadium (V), wherein the compound is doped with a first metal element which is substituted into the Li position in Formula 1, and a second metal element which is substituted into the M position in Formula 1.

In some embodiments, the first metal element may include at least one of aluminum (Al), gallium (Ga), indium (In), titanium (Ti), silicon (Si), germanium (Ge), tin (Sn) or lead (Pb).

In some embodiments, the second metal element may include at least one of tantalum (Ta), niobium (Nb), zirconium (Zr), scandium (Sc), yttrium (Y), or vanadium (V), the second metal element including a different material than M.

In some embodiments, the concentration of each of the first metal element and the second metal element doped into the compound may be above about 0 mol % and no higher than about 0.5 mol % with respect to the compound.

In some embodiments, the compound may have a garnet cubic phase.

### BRIEF DESCRIPTION OF THE FIGURES

FIG. 1 is a flow chart for illustrating a method for preparing an oxide based solid electrolyte according to embodiments of the inventive concept;

FIG. 2 is a graph displaying x-ray diffraction (XRD) patterns of intermediates prepared according to Experimental Example 1 and comparative examples;

FIG. 3 is a graph displaying XRD patterns of an oxide based solid electrolyte prepared according to Comparative Example 2;

FIG. 4 is a graph displaying XRD patterns of an oxide based solid electrolyte prepared according to Experimental Example 1;

FIG. 5 is a graph analyzing the ionic conductivity, relative density, and cross section of an oxide based solid electrolyte prepared according to Comparative Example 2;

FIG. 6 is a graph analyzing the ionic conductivity, relative density, and cross section of an oxide based solid electrolyte prepared according to Experimental Example 1;

FIG. 7 is a graph in which activation energies are determined for oxide based solid electrolytes prepared according to Experimental Example 1 and Comparative Example 2; and

FIG. 8 is a graph measuring the impedance and ion conductivity of an oxide based solid electrolyte prepared according to Experimental Example 2.

### DETAILED DESCRIPTION

Exemplary embodiments of the inventive concept are described with reference to accompanying drawings in order to sufficiently describe the configuration and effects of the present invention. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. It will be understood by a person skilled in the art that the inventive concept could be carried out in suitable environments. Like reference numerals refer to like elements throughout.

It will be further understood that the terms “comprises” and/or “comprising”, when used in this specification, specify the presence of stated elements, steps, operations, and/or components, but do not preclude the presence or addition of one or more other elements, steps, operations, and/or components.

Unless otherwise defined, all terms used herein have the same meaning as commonly understood by one of ordinary skill in the art to which this invention belongs.

Hereinafter, the present invention will be explained in detail by describing exemplary embodiments of the inventive concept, with reference to the accompanying drawings.

An oxide based solid electrolyte according to embodiments of the inventive concept may include a compound represented by Formula 1.

LiₓLa₃M₂O₁₂ <Formula 1>

In Formula 1, x may be about 5 to 9. A metal represented by M (hereinafter, written as metal (M)) may be one of tantalum (Ta), niobium (Nb), zirconium (Zr), scandium (Sc), yttrium (Y), and vanadium (V). In detail, when metal (M) includes a metal having a valence of +3, x may be 9. In contrast, when metal (M) includes a metal having a valence of +4, x may be 7. In further contrast, when metal (M) includes a metal having a valence of +5, x may be 5. The compound may have a garnet cubic phase. Here, a garnet crystal is typically represented by A₃B₂C₃O₁₂, and a cubic unit cell indicates a crystal system composed of eight A₃B₂C₃O₁₂ units.

The oxide based solid electrolyte may contain a first dopant. In detail, the first dopant may be substituted into a lithium (Li) site in the crystal structure of the compound. Here, the compound may be doped with the first dopant to a concentration above about 0 mol % and no higher than about 0.5 mol % with respect to the compound. The first dopant may include one of aluminum (Al), gallium (Ga), indium (In), titanium (Ti), silicon (Si), germanium (Ge), tin (Sn), and lead (Pb).

The oxide based solid electrolyte may contain a second dopant. In detail, the second dopant may be substituted into the metal (M) site. Here, the compound may be doped with the second dopant to a concentration above about 0 mol % and no higher than about 0.5 mol % with respect to the compound. The second dopant may include at least one of tantalum (Ta), niobium (Nb), zirconium (Zr), scandium (Sc), yttrium (Y), vanadium (V), and combinations thereof. Here, the second dopant may include a different element from metal (M).

The first dopant enhances the crystallinity of the oxide based solid electrolyte having a cubic phase, and consequently, the oxide based solid electrolyte may exhibit high ionic conductivity. The second dopant may be substituted into the site of the metal (M) element and thereby change the size of the crystal lattice in the vicinity thereof. Due to such a change in the crystal lattice, a shortest path may be established for the lithium (Li) ion, and the oxide based solid electrolyte containing the second dopant may exhibit high ionic conductivity.

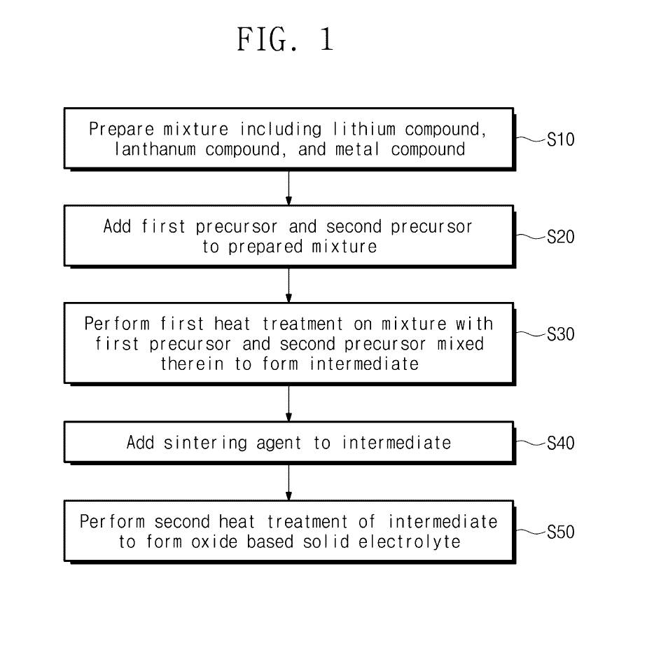

Hereinafter, description is given of a method for preparing an oxide based solid electrolyte according to embodiments of the inventive concept. FIG. 1 is a flow chart for illustrating a method for preparing an oxide based solid electrolyte according to embodiments of the inventive concept.

Referring to FIG. 1, a mixture containing a lithium (Li) compound, a lanthanum (La) compound, and a metal compound may be prepared S10. The lithium (Li) compound may be one of carbonates, chlorides, hydroxides, acetates, perchlorates, nitrates, oxides, and peroxides of lithium (Li). For example, the lithium (Li) compound may include lithium carbonate (LiCO₃), lithium chloride (LiCl), lithium hydroxide (LiOH), lithium acetate (CH₃COOLi), lithium perchlorate (LiClO₄), lithium nitrate (LiNO₃), lithium oxide (Li₂O), or lithium peroxide (Li₂O₂). To prevent the inclusion of impurities, the lithium (Li) compound may exclude metals other than lithium (Li). The lanthanum (La) compound may be one of oxides, nitrates, chlorides, acetates, carbonates, and hydroxides of lanthanum (La). For example, the lanthanum (La) compound may include lanthanum oxide (La₂O₃), lanthanum nitrate hexahydrate (La(NO₃)₃6H₂O), lanthanum chloride (LaCl₃), lanthanum acetate hydrate (La(CH₃CO₂)₃xH₂O), lanthanum chloride heptahydrate (LaCl₃7H₂O), lanthanum nitrate hydrate (La(NO₃)₃xH₂O), lanthanum chloride hydrate (LaCl₃xH₂O), lanthanum carbonate hydrate (La(CO₃)₃xH₂O), or lanthanum hydroxide (La(OH)₃). The metal compound may include acetates, nitrates, chlorides, hydroxides, or oxides containing a metal represented by M (hereinafter, written as metal (M)). Metal (M) may include metals having valences of +3, +4, or +5. For example, metal (M) may include zirconium (Zr), tantalum (Ta), niobium (Nb), scandium (Sc), yttrium (Y), or vanadium (V). That is, the metal compound may include a zirconium (Zr) compound, a tantalum (Ta) compound, a niobium (Nb) compound, a scandium (Sc) compound, a yttrium (Y) compound, or a vanadium (V) compound. For example, the zirconium (Zr) compound may include zirconium oxide (ZrO₂), zirconium chloride (ZrCl₄), zirconium oxynitrate hydrate (ZrO(NO₃)₂xH₂O), or zirconium nitride (ZrN). For example, the tantalum (Ta) compound may include tantalum oxide (Ta₂O₅), tantalum chloride (TaCl₅), tantalum methoxide (Ta(OCH₃)₅), or tantalum ethoxide (Ta(OC₂H₅)₅). For example, the niobium (Nb) compound may include niobium oxide (Nb₂O₅ or NbO₂), niobium chloride (NbCl₅), or niobium nitride (NbN). For example, the scandium (Sc) compound may include scandium(III) oxide (Sc₂O₃), scandium(III) isopropoxide (Sc(OCH(CH₃)₂)₃, scandium(III) nitrate hydrate (Sc(NO₃)₃xH₂O), scandium(III) chloride (ScCl₃), or scandium(III) chloride hydrate (ScCl₃xH₂O). For example, the yttrium (Y) compound may include yttrium(III) oxide (Y₂O₃), yttrium(III) chloride (YCl₃), yttrium(III) nitrate tetrahydrate (Y(NO₃)₃4H₂O), yttrium(III) chloride hexahydrate (YCl₃6H₂O), yttrium isopropoxide oxide (OY₅(OCH(CH₃)₂)₁₃), or yttrium(III) carbonate hydrate (Y₂(CO₃)₃xH₂O). For example, the vanadium (V) compound may include vanadium oxide (V₂O₅), vanadium(II) chloride (VCl₂), vanadium(III) chloride (VCl₃), vanadium(IV) oxide sulfate hydrate (VOSO₄xH₂O), or vanadium(V) oxytriethoxide (OV(OC₂H₅)₃. Here, when the metal compound includes metal (M) having a valence of +3, the stoichiometric ratio of the lithium (Li) compound to the lanthanum (La) compound to the metal compound making up the mixture may be 9:3:2. In contrast, when the metal compound includes metal (M) having a valence of +4, the stoichiometric ratio of the lithium (Li) compound to the lanthanum (La) compound to the metal compound making up the mixture may be 7:3:2. In further contrast, when the metal compound includes metal (M) having a valence of +5, the stoichiometric ratio of the lithium (Li) compound to the lanthanum (La) compound to the metal compound making up the mixture may be 5:3:2. The mixture containing the lithium (Li) compound, the lanthanum (La) compound, and the metal compound may be in the form of a mixed powder.

A first precursor and a second precursor may be added to the prepared mixture S20. The first precursor and the second precursor may be salts including dopants. In detail, the first precursor may be an acetate, a nitrate, a chloride, a hydroxide, or an oxide that includes a first dopant. The first dopant may include a metal element having an atomic diameter equal or similar to that of a lithium (Li) atom. For example, the first dopant may include aluminum (Al), gallium (Ga), indium (In), titanium (Ti), silicon (Si), germanium (Ge), tin (Sn) or lead (Pb). The first dopant may be added so as to be above about 0 mol % and no higher than about 0.5 mol % with respect to the composition of the prepared oxide based solid electrolyte. The second precursor may be an acetate, a nitrate, a chloride, a hydroxide, or an oxide that includes a second dopant. The second dopant may include zirconium (Zr), niobium (Nb), tantalum (Ta), scandium (Sc), yttrium (Y), or vanadium (V). Here, the second precursor may include a different metal from metal (M) of the metal compound. The second dopant may be added so as to be above about 0 mol % and no higher than about 0.5 mol % with respect to the composition of the prepared oxide based solid electrolyte. A mixing operation may be carried out using mechanical mixing, for example, ball milling. Here, in order to prepare a more uniform mixture, an alcohol solution such as methanol, ethanol, or isopropyl alcohol (IPA) may be further added. Elemental lithium (Li), elemental lanthanum (La), metal (M) elements, and elemental oxygen may be uniformly distributed in the mixture through the mixing operation.

A crystallization operation may be performed on the mixture having the first precursor and the second precursor mixed therein. The crystallization operation may include a first heat treatment and a second heat treatment. Hereinafter, crystallization of the mixture is described in detail.

A first heat treatment may be performed on the first precursor and the second precursor to form an intermediate S30. Through the first heat treatment, elemental lithium (Li) may be diffused in between elemental lanthanum (La) and metal (M) elements to from the intermediate. The intermediate may be represented by Formula 1.

LiₓLa₃M₂O₁₂ <Formula 1>

In Formula 1, x may be an integer of about 5 to 9. M may be one of tantalum (Ta), niobium (Nb), zirconium (Zr), scandium (Sc), yttrium (Y), and vanadium (V). The intermediate may have a cubic phase. Due to the intermediate having a cubic phase, in the below-described second heat treatment, the oxide based solid electrolyte having a cubic phase may be easily prepared. That is, impurities and the formation of an oxide based solid electrolyte having a different crystal structure may be minimized by obtaining the intermediate having the targeted crystal structure in the first heat treatment (that is, a calcination operation), and the densification efficiency may be improved in the second heat treatment. The stoichiometric composition and degree of crystallinity of the intermediate may be determined by the conditions of the first heat treatment. The first heat treatment may be carried out under conditions of about 800° C. to 1000° C. When the first heat treatment is carried out under a temperature condition below about 800° C., an intermediate having a tetragonal phase which has a lower lithium (Li) ion conductivity than a cubic phase may be formed, and impurities such as La₂O₃, LiO₂, ZrO₂, or La₂Zr₂O₇ may be formed. When the first heat treatment is carried out at a temperature condition above about 1000° C., there may be an excessive loss of elemental lithium (Li) during the heat treatment, and impurity phases such as La₂Zr₂O₇ or LaAlO₃ may be formed. The first heat treatment may be carried out for about 2 to 4 hours. When the first heat treatment is shorter than about 2 hours, the intermediate may have poor crystallinity. When the first heat treatment is longer than about 4 hours, there may be an increase in the amount of lithium (Li) lost during the heat treatment. Consequently, the yield of the intermediate which is prepared may be low.

Elemental lithium (Li), elemental lanthanum (La), metal (M) elements, and elemental oxygen may be uniformly distributed in the intermediate. Through the first heat treatment, the first dopant may substitute elemental lithium (Li) contained in the intermediate. The closer the size of the first dopant is to elemental lithium (Li), the easier it is for the first dopant to substitute elemental lithium (Li). The first dopant induces the intermediate to become a cubic phase in the first heat treatment, and consequently, the intermediate may exhibit high ionic conductivity. Through the first heat treatment, the second dopant may substitute the metal (M) element contained in the intermediate. The larger the difference in size between the second dopant and the metal (M) element, the greater the increase in size of the crystal lattice may be in the vicinity of the site within the intermediate into which the second dopant is substituted. Due to such a change in the crystal lattice, a shortest path may be established for the lithium (Li) ion, and the intermediate containing the second dopant may exhibit high ionic conductivity.

A sintering agent may be added to the intermediate S40. The sintering agent may include an oxide having a melting point of at most 1000° C. For example, the sintering agent may include boron trioxide (B₂O₃), manganese(IV) oxide (MnO₂), or lithium tetraborate (Li₂B₄O₇). Here, the sintering agent may be added at a ratio of about 0 to 5 mass % of the total mass of the intermediate. The sintering agent may be employed in the grain boundaries of the intermediate to induce cohesion between crystal grains during a below-described second heat treatment. The sintering agent enables a highly dense oxide based solid electrolyte to be formed in the below-described heat treatment. The increased density may reduce the resistance in the grain boundaries to thereby increase the ionic conductivity in the oxide based solid electrolyte. Moreover, the sintering agent may be provided in order to reduce the duration of the second heat treatment. Conversely, the sintering agent may also not be provided.

The second heat treatment may be performed on the intermediate to form the oxide based solid electrolyte S50. The oxide based solid electrolyte may have the same stoichiometric composition as the intermediate. That is, the oxide based solid electrolyte may be represented by Formula 1.

LiₓLa₃M₂O₁₂ <Formula 1>

In Formula 1, x may be an integer of about 5 to 9. M may be one of tantalum (Ta), niobium (Nb), zirconium (Zr), scandium (Sc), yttrium (Y), and vanadium (V).

The oxide based solid electrolyte may have a cubic phase. The oxide based solid electrolyte may have a higher ionic conductivity than the intermediate. The second heat treatment may be carried out under conditions of about 1000° C. to 1200° C. When the second heat treatment is carried out under a temperature condition below about 1000° C., the oxide based solid electrolyte having a cubic phase may not be formed. When the second heat treatment is carried out under a temperature condition above about 1200° C., the impurity content in the oxide based solid electrolyte may increase, or there may be an excessive loss of elemental lithium (Li) caused by vaporization of the elemental lithium (Li). The second heat treatment may be carried out for about 1 to 30 hours. When the second heat treatment is shorter than 1 hour, the crystallinity of the oxide based solid electrolyte may be poor. Loss of elemental lithium may be better prevented in the oxide based solid electrolyte prepared by carrying out the first and second heat treatments than in cases in which the first heat treatment is omitted. In another embodiment, the shape of the intermediate may be modified before performing the second heat treatment. For example, the intermediate may be formed into pellets using a method such as compression molding. The shape or size of the intermediate pellets may be easily controlled by forming the intermediate into a solid powder form. The shape or size of the intermediate may be adjusted so as to be appropriate for use in a lithium battery.

Hereinafter, with reference to experimental examples of embodiments of the inventive concept, methods for preparing oxide based solid electrolytes according to embodiments of the inventive concept, and results of evaluating the properties of the oxide based solid electrolytes are described in greater detail.

### Preparation of Oxide Based Solid Electrolytes

### Experimental Example 1

Lithium carbonate (LiCO₃) which is a lithium source, lanthanum oxide (La₂O₃), and zirconium oxide (ZrO₂) which is a metal (M) source were mixed to prepare a mixed powder. Here, the stoichiometric ratio of lithium (Li) compound to lanthanum (La) compound to metal compound was maintained at 7:3:2.

Aluminum oxide (Al₂O₃) for substitution into a lithium position and tantalum oxide (Ta₂O₅) for substitution into a metal (M) position were added to the mixed powder. The concentration of aluminum oxide (Al₂O₃) and tantalum oxide (Ta₂O₅) added was 0.2 mol % with respect to the composition of the mixed powder. Isopropyl alcohol (IPA) was added to the mixed powder for uniform mixing, and then the mixed powder was mixed for 6 to 12 hours by a ball milling

Powder obtained by drying a mixed slurry in a 100° C. drying oven was calcinated in a 1000° C. reaction furnace for four hours to obtain an intermediate. After grinding the intermediate obtained through the calcination operation into a powder form, the powder was processed through compression molding into pellets having a diameter of 18 mm and a thickness of 2 mm Next, the processed intermediate was sintered in a 1200° C. reaction furnace for 1 to 30 hours to thereby prepare an oxide based solid electrolyte.

### Experimental Example 2

A pellet shaped oxide based solid electrolyte was prepared by performing identical operations to Experimental Example 1. However, in the present experimental example, after grinding the intermediate, a sintering agent was added and mixed with the powder shaped intermediate. 1 mass % of boron trioxide (B₂O₃) with respect to the intermediate was added as the sintering agent.

### Comparative Example 1

A pellet shaped oxide based solid electrolyte was prepared by performing identical operations to Experimental Example 1. However, in the present comparative example, aluminum oxide (Al₂O₃) and tantalum oxide (Ta₂O₅) were not added to the mixed powder.

### Comparative Example 2

A pellet shaped oxide based solid electrolyte was prepared by performing identical operations to Experimental Example 1. However, in the present comparative example, tantalum oxide (Ta₂O₅) was not added to the mixed powder.

### Comparative Example 3

A pellet shaped oxide based solid electrolyte was prepared by performing identical operations to Experimental Example 1. However, in the present comparative example, aluminum oxide (Al₂O₃) was not added to the mixed powder.

### Evaluation of Solid Electrolytes

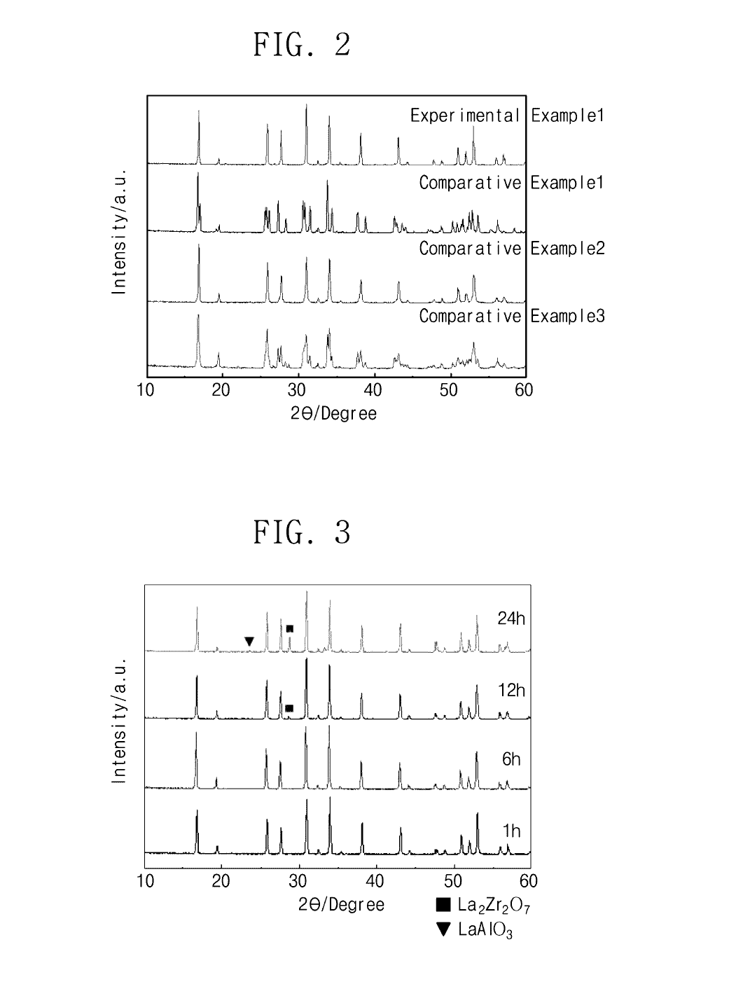

Crystalline phases of the intermediates after undergoing the calcination operation among the operations according to Experimental Example 1 and Comparative Examples 1 to 3 were observed. FIG. 2 is a graph displaying x-ray diffraction (XRD) patterns of intermediates prepared according to Experimental Example 1 and comparative examples. Referring to FIG. 2, Comparative Example 1 shows an XRD pattern of a tetragonal phase, Comparative Example 3 shows an XRD pattern of a mixed phase of a tetragonal phase and a cubic phase, and Comparative Example 2 shows an XRD pattern of a cubic phase. Experimental Example 1 shows an XRD pattern of a cubic phase, and more distinct patterns than those of Comparative Example 2 may be observed. Thus, it may be known that the crystallinity of the cubic phase, which exhibits high ionic conductivity, is higher in Experimental Example 1 than in Comparative Example 2. Moreover, Comparative Example 1 and Comparative Example 3 do not exhibit a purely cubic phase and thus are not expected to exhibit high ionic conductivity.

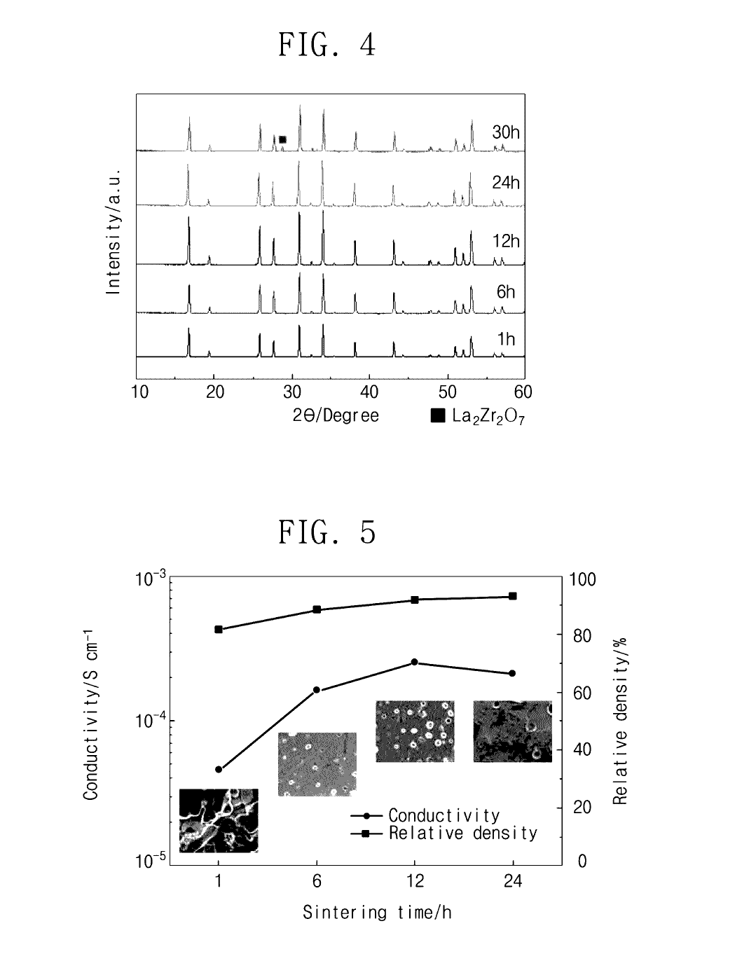

The crystal phase according to the duration of the sintering operation among the preparation operations according to Experimental Example 1 and Comparative Example 2 was observed. FIG. 3 is a graph displaying XRD patterns of the oxide based solid electrolyte prepared according to Comparative Example 2. FIG. 4 is a graph displaying XRD patterns of the oxide based solid electrolyte prepared according to Experimental Example 1. Referring to FIGS. 3 and 4, Experimental Example 1 and Comparative Example 2 were formed as cubic phases, and in Comparative Example 2, impurity phases (La₂Zr₂O₇ and LaAlO₃) started forming after 12 hours of sintering. In contrast, in Experimental Example 1, an impurity phase (La₂Zr₂O₇) started forming after 30 hours, and thus it was observed that less impurities were formed in Experimental Example 1 than in Comparative Example 2.

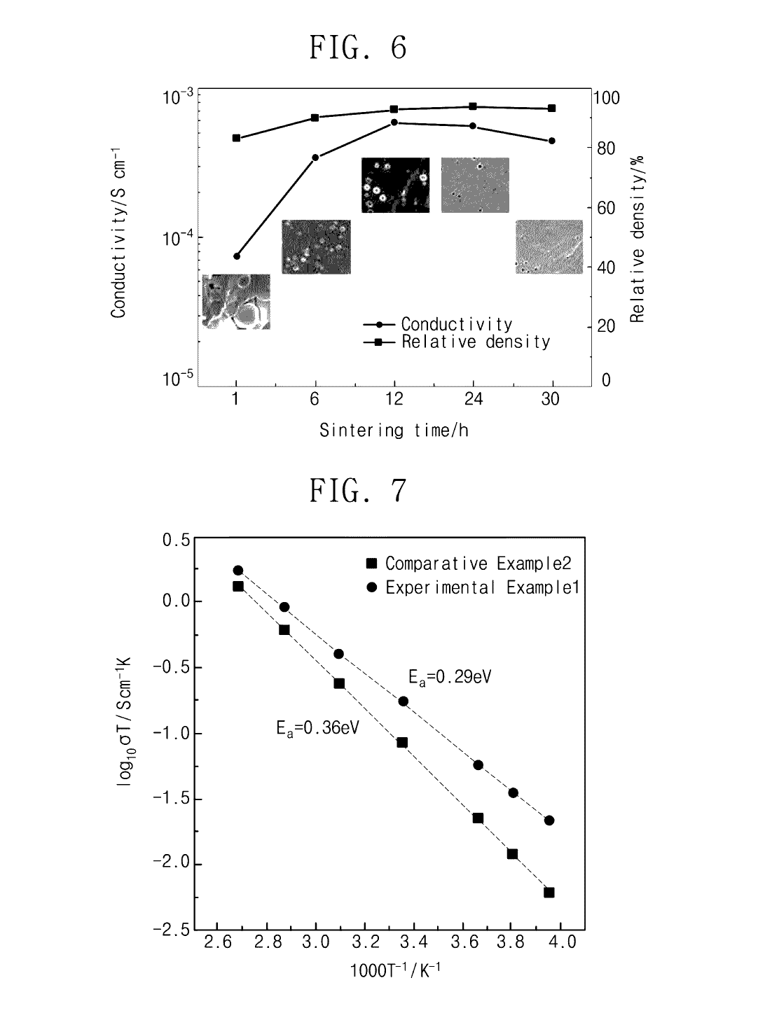

The ionic conductivity, relative density, and cross sections of the oxide based solid electrolytes prepared according to Experimental Example 1 and Comparative Example 2 were analyzed. Cells were manufactured by coating copper to a thickness of 6 μm on both sides of oxide based solid electrolyte pellets prepared according to Experimental Example 1 and Comparative Example 2. The ionic conductivity of the oxide based solid electrolyte was measured by applying an alternating impedance in the range of 10⁻¹ to 10⁵ Hz to the cell. Measurement of the ionic conductivity of the oxide based solid electrolyte was carried out using a frequency response analyzer (Solartron HF 1225). FIG. 5 is a graph analyzing the ionic conductivity, relative density, and cross section of the oxide based solid electrolyte prepared according to Comparative Example 2. FIG. 6 is a graph analyzing the ionic conductivity, relative density, and cross section of the oxide based solid electrolyte prepared according to Experimental Example 1. Referring to FIGS. 5 and 6, although the ionic conductivity and relative density increased according to sintering time for both Comparative Example 2 and Experimental Example 1, the ionic conductivity started to decrease when impurities were formed. When compared to Comparative Example 2, Experimental Example 1 may be observed to have a higher ionic conductivity, and through scanning electron microscope (SEM) images, it can be seen that a denser structure was been formed.

FIG. 7 is a graph in which activation energies are determined for the oxide based solid electrolytes prepared according to Experimental Example 1 and Comparative Example 2. The activation energies for Experimental Example 1 and Comparative Example 2 were derived from Arrhenius plots of the ionic conductivity according to changes in temperature. Referring to FIG. 7, in the range of −20° C. to 100° C., the ionic conductivity of Experimental Example 1 was higher than the ionic conductivity of Comparative Example 2, and the activation energy was lower for Experimental Example 1 than for Comparative Example 2. Thus, it may be observed that Experimental Example 1 has better lithium (Li) ion conducting properties than Comparative Example 2.

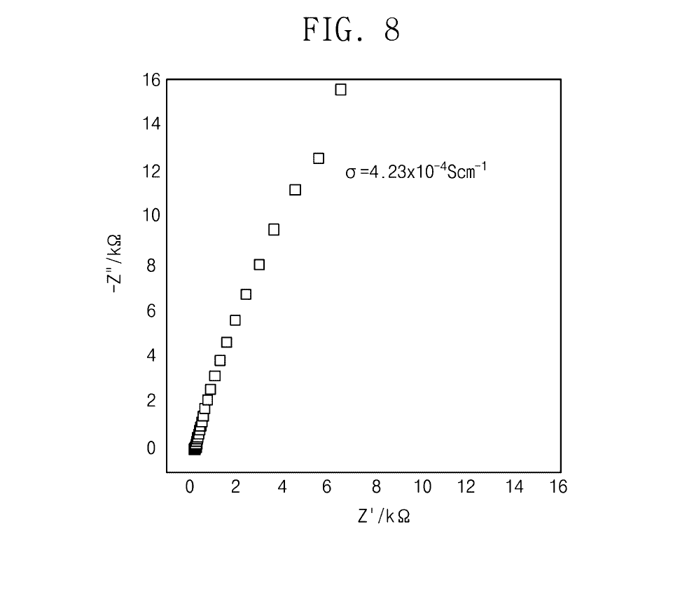

The ionic conductivity of the oxide based solid electrolyte prepared according to Experimental Example 2 was measured. In Experimental Example 2, sintering was performed for 1 hour. FIG. 8 is a graph measuring the impedance and ion conductivity of the oxide based solid electrolyte prepared according to Experimental Example 2. Referring to FIG. 8, Experimental Example 2 exhibits an ionic conductivity of about 4.2310⁻⁴ Scm⁻¹, and thus was observed to have a higher ionic conductivity than the sample of Experimental Example 1 in which sintering was performed for 1 hour (about 7.5110⁻⁵ Scm⁻¹, see FIG. 6). Therefore, in Experimental Example 2, the sintering rate of the pellet is increased due to the sintering agent, and thus when compared to Experimental Example 1, a higher ionic conductivity is exhibited due to a faster ion path being established for pellets subjected to the same duration of sintering, and it may be seen that the heat treatment time is significantly reduced.

An oxide based solid electrolyte according to embodiments of the inventive concept may be represented by the compositional formula LiₓLa₃M₂O₁₂ and comprise a first dopant and a second dopant. The first dopant may be substituted into an elemental lithium (Li) site such that the oxide based solid electrolyte may be induced and stabilized into a cubic phase in a first heat treatment, and the second dopant may be substituted into a metal (M) element site to change the size of the crystal lattice in the vicinity thereof. Consequently, the ionic conductivity and crystallinity of the oxide based solid electrolyte may be improved.

In addition, in a method for preparing an oxide based solid electrolyte according to embodiments of the inventive concept, a first dopant may induce the formation of a cubic phase in a first heat treatment, and a sintering agent may be added before a second heat treatment to reduce the operation time of the second heat treatment. Therefore, the vaporization of elemental lithium and the formation of impurity phases may be suppressed. The oxide based solid electrolyte prepared through some embodiments of the inventive concept may be highly pure and exhibit high ionic conductivity.

Although the exemplary embodiments of the present invention have been described with reference to the accompanying drawings, it is understood that various changes and modifications can be made by a person with ordinary skill in the art within the spirit and scope of the present invention. Therefore, it is understood that the embodiments described above are merely exemplary and not limiting in any way.

What is claimed is:

1. A method for preparing an oxide based solid electrolyte, the method comprising:
preparing a mixture including a lithium (Li) compound, a lanthanum (La) compound, and a metal compound, the metal compound including a first metal element represented by M;
adding a first precursor including a second metal element and a second precursor including a third metal element to the mixture; and
performing a crystallization operation to form a compound from the mixture having the first precursor and the second precursor mixed therein,
wherein the compound is doped with the second and third metal elements and represented by Formula 1,
LiₓLa₃M₂O₁₂ <Formula 1>
where x is an integer of about 5 to 9 and M is one of tantalum (Ta), niobium (Nb), zirconium (Zr), scandium (Sc), yttrium (Y), and vanadium (V).

2. The method of claim 1, wherein the first and second metal elements comprise different materials from each other, the second metal element being substituted into the Li position in Formula 1 and the third metal element being substituted into the M position in Formula 1.

3. The method of claim 2, wherein the second metal element comprises at least one of aluminum (Al), gallium (Ga), indium (In), titanium (Ti), silicon (Si), germanium (Ge), tin (Sn) or lead (Pb).

4. The method of claim 2, wherein the third metal element comprises at least one of tantalum (Ta), niobium (Nb), zirconium (Zr), scandium (Sc), yttrium (Y), or vanadium (V).

5. The method of claim 1, wherein the compound comprises a cubic phase.

6. The method of claim 1, wherein the performing of the crystallization operation comprises:
performing a first heat treatment on the compound to form an intermediate that has a cubic phase; and
performing a second heat treatment on the intermediate to form the compound, wherein the intermediate has the same stoichiometric composition as the compound.

7. The method of claim 6, wherein the compound has a higher ionic conductivity than the intermediate.

8. The method of claim 6, wherein the first heat treatment is performed for about 2 to 4 hours at about 800° C. to 1000° C.

9. The method of claim 6, further comprising adding a sintering agent to the intermediate before performing the second heat treatment.

10. The method of claim 9, wherein the sintering agent comprises one of boron trioxide (B₂O₃), manganese(IV) oxide (MnO₂), and lithium tetraborate (Li₂B₄O₇).

11. The method of claim 9, wherein the second heat treatment is performed for about 1 to 30 hours at about 1000° C. to 1200° C.

12. An oxide based solid electrolyte comprising a compound represented by Formula 1,
LiₓLa₃M₂O₁₂ <Formula 1>
where x is an integer of about 5 to 9 and M is one of tantalum (Ta), niobium (Nb), zirconium (Zr), scandium (Sc), yttrium (Y), and vanadium (V),
wherein the compound is doped with a first metal element which is substituted into the Li position in Formula 1, and a second metal element which is substituted into the M position in Formula 1.

13. The oxide based solid electrolyte of claim 12, wherein the first metal element comprises at least one of aluminum (Al), gallium (Ga), indium (In), titanium (Ti), silicon (Si), germanium (Ge), tin (Sn) or lead (Pb).

14. The oxide based solid electrolyte of claim 12, wherein the second metal element comprises at least one of tantalum (Ta), niobium (Nb), zirconium (Zr), scandium (Sc), yttrium (Y), or vanadium (V), the second metal element comprising a different material than M.

15. The oxide based solid electrolyte of claim 12, wherein the concentration of each of the first metal element and the second metal element doped into the compound is above about 0 mol % and no higher than about 0.5 mol % with respect to the compound.

16. The oxide based solid electrolyte of claim 12, wherein the compound comprises a garnet cubic phase.
